(19) United States
(12) Patent Application Publication
(10) Pub. No.: US 2004/0254857 A1
(43) Pub. Date: Dec. 16, 2004

(54) Banner advertisement method and banner advertisement system

(76) Inventor: Katsushi Onizuka, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/494,378

(22) PCT Filed: Oct. 31, 2002
(86) PCT No.: PCT/JP02/11403

(30) Foreign Application Priority Data
Nov. 1, 2001 (JP) 2001-374996
Jul. 25, 2002 (JP) 2002-216358

(51) Int. Cl. G06F 17/60

(52) U.S. Cl. 705/27

(57) ABSTRACT

A banner advertising method can advertise effectively in the Internet and calculate appropriate expense for the advertisements. The method includes: a click counting step (S109) of counting clicks made on the banner advertisement in each of the banner-carrying web pages within a predetermined period of time; a click totalizing step (S115) of obtaining a total number of clicks by totalizing the counts of clicks made in all of the banner-carrying web pages; a rate-per-click calculating step (S116) of calculating a rate to be paid for each of the clicks, by dividing a total advertisement payment for the banner advertisement by the total number of clicks; and an advertisement payment calculating step (S117) of calculating an advertisement payment for the banner advertisement in each of the banner-carrying web pages, by multiplying the rate by the count of clicks in each of the banner-carrying web pages.

### TECHNICAL FIELD

The present invention relates to banner advertising methods for advertisements through the Internet to be displayed on personal computers and mobile telephones. Specifically, the present invention relates to banner advertising methods capable of increasing effects of advertisements and calculating appropriate payment for the advertisements.

### BACKGROUND ART

For purposes of transactions such as selling goods through the Internet, commodity web pages are created in order to explain the offered goods and services. However, creating the web page is not enough. It is still difficult to let a mass of consumers be aware of the web page. So, a number of advertising media are employed in order to advertise the commodity web page.

A popular way of advertising is to put a banner advertisement on other web pages. The banner advertisement is placed in e.g. an extra space of the web pages, and clicking on the banner advertisement enables to view the commodity web page. The owner of the web page who provides the space for the banner advertisement of the commodity web page receives payment for the advertisement.

In order to calculate the payment for the advertisement, two methods are prevalent; the click counting method and the success rewarding method. In the click counting method, a rate to be paid for a click on the banner advertisement is set in advance, then clicks on the banner advertisement are counted, and the number of clicks is multiplied by the rate to obtain the payment for advertisement. On the other hand, in the success rewarding method, a predetermined success reward is paid as the payment for advertisement if a purchase is made at the commodity web page visited by clicking on the banner advertisement. Normally, a few percentage of the selling price is paid as the payment for advertisement.

If the click counting method is used, the payment for advertisement increases proportionally to the number of clicks. This often provokes purposeful clicking on the banner advertisement by the owner of the web page or people related thereto, to increase the number of clicks. In an attempt to solve this problem, the number of visits to the web page where the banner advertisement is placed can be counted and the number of clicks on the banner advertisement can be compared, to obtain a clicking ratio. Such a number enables to watch for foul clicks to a certain extent. However, with this method, it is difficult to give a appropriate count on valid clicks.

On the other hand, when the success rewarding method is used, it is unrealistic to expect payment for advertisement from a banner advertisement placed, because probability for a purchase via a banner advertisement placed in a web page is extremely low, being in a range of 0.01%-0.001%. For this reason, with the success rewarding method, it is difficult to find web pages which are willing to put banner advertisements.

Internet shopping malls provide opportunities for selling goods. However, the operator of the shopping mall does not advertise the goods offered by the sellers. For this reason, taking part in the shopping mall does not generate as significant sales promotion effect as might be expected.

Internet auctions also provide opportunities but auctions are primarily a transaction between two individuals, and often articles placed in the auction are single, non-substitutable items, making the advertisement on the articles more difficult. For this reason, many articles on the auctions are noticed by none until the end of the auction period.

### DISCLOSURE OF THE INVENTION

The present invention provides a banner advertising method capable of increasing effects of advertisements in the Internet and calculating appropriate payments for the advertisements.

An invention disclosed in claim 1 is a banner advertising method involving two or a greater number of banner-carrying web pages each carrying a banner advertisement relevant to an object of advertisement, and an advertisement web page accessible by clicking on the banner advertisement to an advertisement of the object. Each of the web pages is provided on Internet, and the method calculates an advertisement payment for the banner advertisement through steps including: a click counting step of counting clicks made on the banner advertisement in each of the banner-carrying web pages within a predetermined period of time; a click totalizing step of obtaining a total number of clicks by totalizing the counts of clicks made in all of the banner-carrying web pages; a rate-per-click calculating step of calculating a rate to be paid for each of the clicks, by dividing a total advertisement payment for the banner advertisement by the total number of clicks; and an advertisement payment calculating step of calculating an advertisement payment for the banner advertisement in each of the banner-carrying web pages, by multiplying the rate by the count of clicks in each of the banner-carrying web pages.

The object of the advertisement includes many, such as goods, services, questionnaires, company image promotion, and event information. Likewise, the banner-carrying web page can be a web page relevant to the object of advertisement but not limited thereto, and may be a web page irrelevant to the object of advertisement.

There is no limitation to the mode of the banner advertisement; namely, the banner advertisement may be a combination of graphics and characters, characters only, or any other modes. There is no limitation either to the mode of the web page in which the banner advertisement is placed.

Of course there is no specific limitation either, to terminal equipment used for viewing the web pages, as far as it can be connected to the network. For example, the terminal equipment may be desktop personal computers, mobile information terminals and cellular phones.

If the banner advertisement is utilized for a purpose of selling goods for example, an ordering page can be created and linked to the advertisement page, so that a purchase order of the commodity can be made from this ordering page.

The click counting step is performed by counting clicks which are made by visitors to the web page, for each of the banner-carrying web pages. The click counting step is performed for each advertisement period agreed in e.g. a contract, for calculation of advertisement payment and others for this particular period.

A variety of methods can be utilized to perform this click counting step. For example, a system operating server can be provided on the Internet so that clicking on the banner advertisement will enable to view the advertisement web page via the system operating server, while the clicks are counted. Alternatively, the banner-carrying web page can include a click reporting means which reports clicking information to the system operating server when a click is made.

The click totalizing step totalizes the counts of clicks in all of the banner-carrying web pages, thereby obtaining a total number of clicks on all of the banner advertisements related to the banner-carrying web pages. The click totalizing step can be performed by the system operating server which counts the clicks.

The rate-per-click calculating step divides a total advertisement payment for the banner advertisement by the total number of clicks, thereby calculating a rate per click, i.e. a rate to be paid for each of the clicks. According to the present invention, the calculation of the rate per click is based on the total number of clicks, which is a sum of the number of clicks which yielded a purchase, the number of clicks which only yielded a visit to the commodity web page, and the number of click which have been made on foul purposes.

The total advertisement payment is a total amount of money to be distributed to owners of the web pages, as a banner advertisement expense. There is no specific limitation to how the total advertisement payment should be determined. The total advertisement payment may be a fixed amount, or may be calculated proportionally to a quantity of sales of the goods etc., i.e. with a certain percentage of a selling price being a predetermined rate for the advertisement payment.

The advertisement payment calculating step obtains an advertisement payment for the banner advertisement to each of the banner-carrying web pages. According to the present invention, the advertisement payment is calculated by multiplying the rate per click by the count of clicks in each of the banner-carrying web pages.

According to the present invention, advertisement payment is determined in proportion to the number of clicks made on the banner advertisement, and the rate per click will decrease if the number of foul clicks increases. Thus, the present invention has an advantage of discouraging attempts to make foul clicks.

An invention disclosed in claim 2 is the banner advertising method further including: an advertising outcome calculating step of calculating an outcome from the web page visited via the banner advertisement, for each of the banner-carrying web pages; a total outcome calculating step of calculating a total outcome, by totalizing the outcomes for all of the banner-carrying web pages; and a total advertisement payment calculating step of calculating the total advertisement payment based on the total outcome.

The advertising outcome calculating step calculates a variety of outcomes from the advertisement web page visited via clicking on the banner advertisement. The outcome is not limited to a quantity or value of sales. For example, the number of participations to a prize contest and the number of questionnaires responded can be the outcome.

The advertising outcome can be measured by e.g. counting a case in which a purchase order is made through an advertisement web page accessed via the banner advertisement.

The total outcome calculating step is performed by calculating a total of the outcomes in all of the banner-carrying web pages in which the banner advertisement was placed. For example, the step can be performed by totalizing quantities or values of sales from the advertisement web pages accessed via the banner advertisement.

The total advertisement payment calculating step obtains a total amount of money to be distributed to owners of web pages as a banner advertisement expense. The total advertisement payment can be proportional to the total outcome of the banner advertisement or a combination of a predetermined fixed amount of fee and a portion proportional to the total outcome of the banner advertisement. If the total advertisement payment is proportional to the outcome, no disadvantage is incurred to the advertiser even if there is a large number of foul clicks. The total advertisement payment may be calculated by subtracting a system operating cost from an advertisement expense paid by the advertiser.

An invention disclosed in claim 3 is the banner advertising method, further including a success reward calculating step of calculating a success reward based on the outcome for each of the banner-carrying web pages, for the success reward to be added to the advertisement payment.

If the advertisement payment consists only of payment in accordance with the number of clicks made on the banner advertisement, there is a case in which a banner-carrying web page which has yield an outcome can receive only a very small amount of the advertisement payment due to a very small number of clicks. Such a case can be disadvantageous to the owner of this banner-carrying web page. Thus, by appropriating a success reward for the banner-carrying web page which has yielded an outcome such as sales, it becomes possible to make a fair distribution of the advertisement cost paid by the advertiser. Further, it enables to attract more powerful advertisement web pages while discouraging foul clicks, and to further increase the effect of banner advertisement.

The success reward calculating step appropriates a success reward to a banner-carrying web page which has yielded an outcome, in accordance to the outcome. For example, the success reward can be calculated by multiplying a quantity of sales by a few percentage of a unit price of goods.

An invention disclosed in claim 4 is for the object of advertisement which relates to a commodity or service for sale. The outcome is provided by a quantity of sales and/or a value of sales of the commodities or service, whereas the calculation of the total advertisement payment is based on the quantity of sales and/or the value of sales.

An invention disclosed in claim 5 is the banner advertising method, wherein the advertisement web page has a link to an ordering page, and purchase of the commodity or service and counting of the outcome are made via the ordering page. By managing the ordering page, calculation of a success reward for example can be made easily.

There is no specific limitation on an entity which manages the ordering page. For example, an operator of a shopping mall can manage the ordering page, using a shopping mall operation server. Alternatively, a separate operation server may be placed on the Internet for the management of the ordering page, whereby an entity other than the shopping mall operator can manage a banner advertisement system according to the present invention.

An invention disclosed in claim 6 is the banner advertising method, wherein a predetermined success reward is appropriated for an owner of the banner-carrying web page if a purchase order is made through the ordering page. By appropriating a success reward for an owner of a banner-carrying web page, it becomes easy to attract banner-carrying web pages. Further, by offering a success reward in addition to an advertisement payment, it becomes possible to select more effective banner-carrying web pages to give a higher priority in the placement of the banner advertisement.

An invention disclosed in claim 7 is an application of the present invention to a case in which the advertisement web page and/or the banner-carrying web pages are commodity web pages constituting a shopping mall on the Internet.

It is common that a shopping mall includes commodity web pages for sales purposes, but sometimes the shopping mall does not have an appropriate sales promotion system, leading to inability to attract customers. Using banner advertisements according to the present invention enables to increase the number of customers who visit the commodity web pages.

There is no specific limitation to a body to which the advertisement web page and the banner-carrying web pages belong to. The advertisement web page and the banner-carrying web pages can be commodity web pages which belong to the same shopping mall. Placing a banner advertisement each other in web pages featuring relevant commodities and belonging to the same shopping mall makes it easy to find a commodity of desire. Further, placing a banner advertisement in web pages related to the same or similar commodity enables customers to do shopping while comparing a number of commodities. This makes easy to use the shopping mall.

Further, a banner advertisement of an advertisement web page belonging to a shopping mall can be placed in a variety of web pages which do not belong to the shopping mall for promoted sales. Inversely, a banner advertisement of an advertisement web page not belonging to a shopping mall can be placed in a variety of web pages which belong to the shopping mall. Such an arrangement can be effective for a purpose of making a market research for a new commodity.

An invention disclosed in claim 8 is for a case where the object of advertisement is gathering information. In this banner advertising method, the system calculates the advertisement payment and/or the success reward as well as a cooperation reward to information providers. A survey using a questionnaire conducted for market research falls on this category, for example. In this case, owners of the banner-carrying web pages may be paid, in addition to the advertisement payment and/or the success reward, a cooperation reward to information providers.

Inventions disclosed in claim 9 through claim 12 are applications of the present invention to an auction conducted on the Internet.

The auction is a category of commodity transactions, and it is important to attract a large number of prospect bidders. Using a banner advertisement method according to the present invention enables to increase the number of bidders thereby making the transactions more active in the auction.

The invention disclosed in claim 9 is a banner advertising method in Internet auctioning for advertising an article offered in an auction conducted on Internet, and includes: creation of an auction article web page featuring the article, and a bidding page linked to the auction article web page, and placement of a banner advertisement linked to the auction article web page in another auction article web page which belongs to the auction and/or a banner-carrying web page which does not belong to the auction.

Conventionally, articles offered in an auction are rarely advertised, and it has been difficult to attract a large number of prospect bidders. For this reason, many auction articles have been bid by none till the end of the auction period. For customers, it has been difficult to find an article of desire among a large number of articles. Further, it has not been possible to make bidding while comparing the same or similar articles.

According to the present invention, a banner advertisement relating to an auction article can be placed in other web pages. For example, the banner advertisement can be placed in web pages featuring the same or similar articles to the object of the banner advertisement. Then, it becomes possible to bid while moving around these web pages and checking the same or similar articles. Therefore, the present invention remarkably improves convenience and increases ease of use in an auction system on the Internet, promoting active transactions in the auction. Further, one can place a banner advertisement relevant to one's own article in advertisement web pages which do not belong to the auction, thereby letting the relevant auction be known widely.

If a plurality of auction article web pages put each other's banner advertisements, advertisement expense to be paid by the advertiser may be offset by advertisement payment from the banner-carrying web page, so that the system can be operated without a burden borne by the exhibitors of the articles.

Of course, the system may require an advertisement payment for the banner advertisement as in an invention disclosed in claim 10.

The invention disclosed in claim 10 is the banner advertising method in Internet auctioning, and includes: a click counting step of counting clicks made on the banner advertisement in each of the web pages within a predetermined bidding period; a click totalizing step of obtaining a total number of clicks by totalizing the counts of clicks made in all of the web pages in which the banner advertisement is placed; a rate-per-click calculating step of calculating a rate to be paid for each of the clicks, by dividing a total advertisement payment for the banner advertisement by the total number of clicks; and an advertisement payment calculating step of calculating an advertisement payment for the banner advertisement in each of the web pages, by multiplying the rate by the count of clicks at each of the web pages.

The click counting step, the click totalizing step, the rate-per-click calculating step and the advertisement payment calculating step are performed as described for the invention disclosed in claim 1. Determination on the successful bidder and other procedures are conducted as in conventional auctions.

The above method discourages attempts for foul clicking made to earn advertisement payment, and enables fair distribution of an advertisement payment, thereby bringing about the same advantages as in the inventions described earlier. Further, the method will increase the number of visitors to the auction article web pages, leading to an increased number of bidders, and increased probability that the articles will be successfully bid.

An invention disclosed in claim 11 is the banner advertising method, wherein a successful-bid reward is appropriated for a web page in which the banner advertisement is placed, if the article has been successfully bid by a bidder who made a visit, via this particular web page, to the auction article web page.

Paying a successful-bid reward to a banner advertisement which has contributed to a successful bidding creates an opportunity that the reward can be given even if one's own article has not been successfully bid. This significantly eases the burden to be borne by the exhibitors, while enabling to attract a large number of exhibitors. Thus, it becomes possible to make the auction more active. It should be noted here that the successful-bid reward can be added to the advertisement payment described in claim 10.

An invention disclosed in claim 12 is the banner advertising method, wherein the banner advertisement placed in each web page is replaced by another banner advertisement at a predetermined time interval. There is no specific limitation to the interval at which the banner advertisement is replaced. For example, the interval may be a predetermined number of days or a predetermined number of clicks made on the banner advertisement.

Replacing the banner advertisements enables to produce consistent effect from advertising. Further, it enables to increase interest from those attending the auction, and to increase the number of visits to the auction article web pages. Further, an increased number of bidders increases probability for successful bids of the articles in the auction.

An invention disclosed in claim 13 is a banner advertising system involving two or a greater number of banner-carrying web pages each carrying a banner advertisement relevant to an object of advertisement, and an advertisement web page accessible by clicking on the banner advertisement to an advertisement of the object. Each of the web pages is provided on Internet, and the system calculates an advertisement payment for a visit to the advertisement web page via a click made on the banner advertisement. The system includes: a click counter capable of counting clicks made on the banner advertisement in each of the banner-carrying web pages within a predetermined period of time; a click totalizer for obtaining a total number of clicks by totalizing the counts of clicks made in all of the banner-carrying web pages; a rate-per-click calculator for calculating a rate to be paid for each of the clicks, by dividing a total advertisement payment for the banner advertisement by the total number of clicks; and an advertisement payment calculator for calculating an advertisement payment for the banner advertisement in each of the banner-carrying web pages, by multiplying the rate by the count of clicks in each of the banner-carrying web pages.

An invention disclosed in claim 14 is the banner advertising system, further including: an outcome calculator for calculating an advertising outcome from the banner advertisement in each of the banner-carrying web pages; a total outcome calculator for calculating a total outcome, by totalizing the outcomes in all of the banner-carrying web pages; and a total advertisement payment calculator for calculating the total advertisement payment based on the total outcome.

An invention disclosed in claim 15 is the banner advertising system, further including a success reward calculator for calculating a success reward based on the outcome for each of the banner-carrying web pages.

An invention disclosed in claim 16 is the banner advertising system, wherein the outcome calculator calculates the outcome via an ordering page linked to the advertisement web page.

An invention disclosed in claim 17 is the banner advertising system, further including an automatic creator for creation of the banner advertisement and/or the ordering page.

An invention disclosed in claim 18 is a banner advertising method in an Internet auction, and includes: auction article web pages each featuring an article offered in the auction, bidding means including a bidding page linked to the auction article web pages, and a selector for selecting a successful bidder. The system places a banner advertisement linked to the auction article web pages in other auction article web pages which belong to the auction and/or banner-carrying web pages which do not belong to the auction.

An invention disclosed in claim 19 is the banner advertising system in an Internet auction, and includes: a click counter capable of counting clicks made on the banner advertisement in each of the web pages within a predetermined period; a click totalizer for obtaining a total number of clicks by totalizing the counts of clicks made in all of the banner-carrying web pages; a rate-per-click calculator for calculating a rate to be paid for each of the clicks, by dividing a total advertisement payment for the banner advertisements by the total number of clicks; and an advertisement payment calculator for calculating an advertisement payment for the banner advertisement in each of the banner-carrying web pages, by multiplying the rate by the count of clicks in each of the banner-carrying web pages.

An invention disclosed in claim 20 is the banner advertising system in an Internet auction, further including a total advertisement payment calculator for calculating the total advertisement payment based on a price and/or a quantity of the article which has been successfully bid.

An invention disclosed in claim 21 is the banner advertising system in an Internet auction, further including a success reward calculator for calculating a success reward based on the price and/or the quantity of the article which has been successfully bid, for the web pages in which the banner advertisement is placed.

An invention disclosed in claim 22 is the banner advertising system in an Internet auction, further including an automatic banner advertisement creator for creation of the banner advertisement relevant to the article.

A banner advertisement has a very simple construction. Therefore, by providing predetermined patterns from which advertisers can choose, and by providing an arrangement through which the advertisers can make and register their own banner advertisements, it becomes easy to attract banner-carrying web pages. In particular, if the advertiser already has a commodity web page, banner advertisement creation will be the only thing to be done, making easy the operation of the system.

An invention disclosed in claim 23 is the banner advertising system in an Internet auction, further including a banner advertisement placer for automatic selection of a web page which is in a predetermined relationship with the auction article featured in the banner advertisement, and automatic placement of the banner advertisement in the selected web page.

An invention disclosed in claim 24 is the banner advertising system in an Internet auction, further including a web page creator for automatic creation of the auction article web page and/or the bidding page.

The automatic creation of the auction article web page and/or the bidding page enables to shorten a period of time necessary from the application for the auction to the placement of a banner advertisement, and to increase work efficiency.

An invention disclosed in claim 25 is the banner advertising system in an Internet auction, wherein the internet auction includes a plurality of auction article web pages. The system further includes a banner advertisement replacer for replacement of the banner advertisement with another, in each of the auction article pages at a predetermined time interval.

An invention disclosed in claim 26 is the banner advertising system in an Internet auction, further including a banner advertisement updater for automatic deletion of the auction article web page and the banner advertisement thereof, and automatic replacement with another auction article web page and a banner advertisement thereof.

### BRIEF DESCRIPTION OF THE DRAWINGS

FIG. 1 outlines a banner advertising system according to a first embodiment of the present invention.

FIG. 2 shows an overall configuration of the system in FIG. 1.

FIG. 3 shows a configuration of a system database server in FIG. 2.

FIG. 4 is an operation flowchart of the banner advertising system in FIG. 2.

FIG. 5 shows a calculation method for a total payment for advertisement and a rate per click.

FIG. 6 outlines a banner advertising system according to a second embodiment of the present invention.

FIG. 7 shows an overall configuration of the system in FIG. 6

FIG. 8 is an operation flowchart of the banner advertising system in FIG. 7.

FIG. 9 is an operation flowchart of the banner advertising system in FIG. 7.

FIG. 10 outlines a banner advertising system according to a third embodiment of the present invention.

FIG. 11 outlines a banner advertising system according to a fourth embodiment of the present invention.

FIG. 12 shows an overall configuration of the system in FIG. 11.

FIG. 13 shows a configuration of a system database server in FIG. 12.

FIG. 14 is an operation flowchart of the banner advertising system in FIG. 12.

FIG. 15 shows an example of auction article web pages in an Internet auction system.

FIG. 16 illustrates how banner advertisements placed in a plurality of web pages are rotated among the web pages.

FIG. 17 illustrates how banner advertisements are deleted and a new advertisement is placed.

### BEST MODE FOR CARRYING OUT THE INVENTION

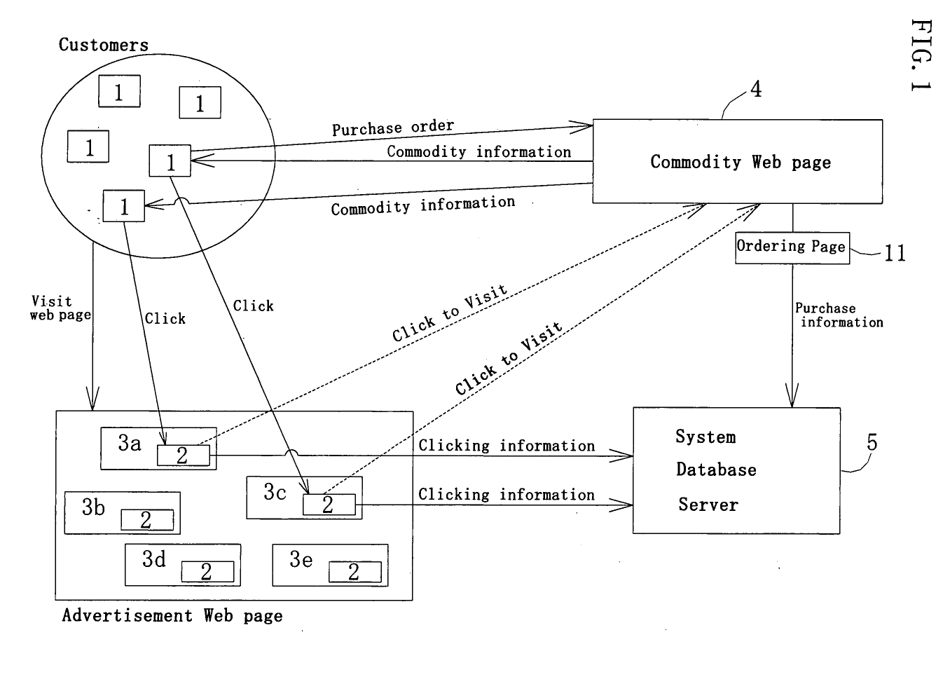

FIG. 1 through FIG. 5 show a first embodiment of the present invention. The embodiment is an application of the present invention to a banner advertising system in general merchandising activities conducted through the Internet.

FIG. 1 shows an outline of the banner advertisement system. Customers 1 view banner-carrying web pages 3a-3e containing a banner advertisement 2 of a commodity. It should be noted that FIG. 1 only shows a limited number of customers 1 and a limited number of banner-carrying web pages 3a-3e; however, there is no limitation to the number of the customers or the number of the banner-carrying web pages.

Some of the customers who visit the banner-carrying web pages 3a-3e click on the banner advertisement 2 contained in the web pages, to visit a commodity web page 4 in which the commodity is promoted in an advertisement. Then, some of the customers who visit the commodity web page 4 place a purchase order for the commodity via an ordering page 11 linked to the commodity web page.

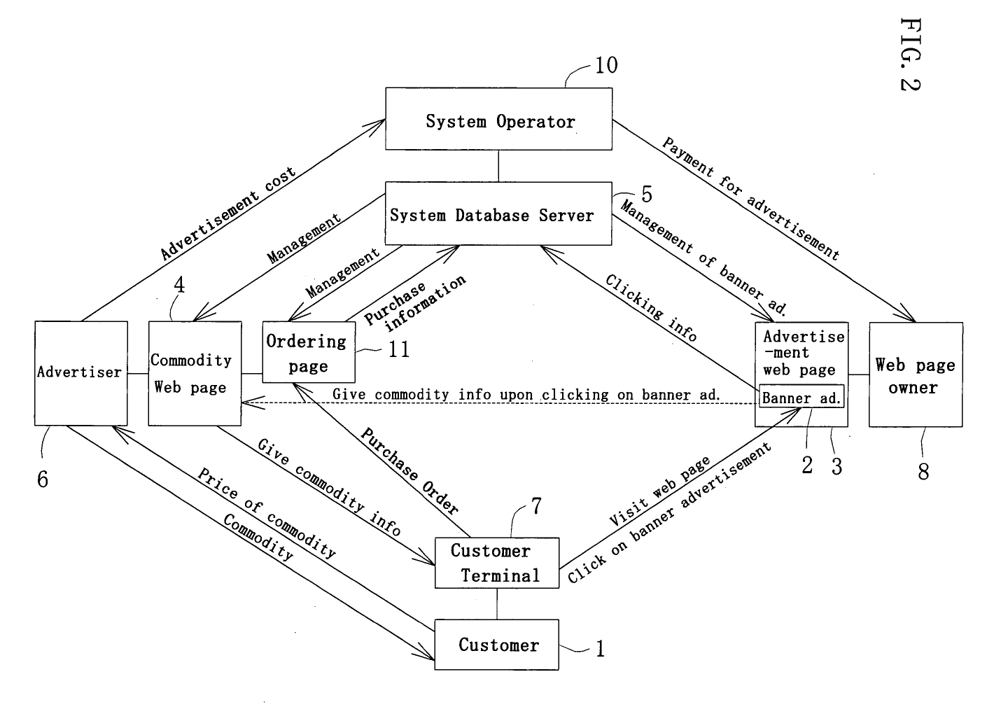

FIG. 2 outlines a configuration of the system. The banner advertising system according to the present embodiment involves an advertiser 6 who owns a commodity web page 4, customers 1 who make visits to the web page from a terminal 7 via the Internet, web page owners 8 who own banner-carrying web pages 3 in each of which a banner advertisement 2 is placed, and a system operator 10 who owns a system database server 5.

The advertiser 6 pays to the system operator 10 an advertising expense in accordance with an amount or value of sales of the commodity, as a payment for banner advertisement for a period agreed upon in a contract for example. The system operator 10 subtracts an operational fee from the advertising expense, to obtain a total advertisement payment, and distributes the total advertisement payment to the owners 8 of the banner-carrying web pages 3.

According to the present embodiment, the commodity is shipped directly from the advertiser 6 to the customers 1, and the price of the commodity is paid directly from the customers 1 to the advertiser 6. However, the present embodiment places no limitation on how the commodity is delivered or how the price is paid. For example, the system operator may take the part of shipping the commodity. Further, the payment between the customers 1 and the advertiser 6, and/or the payment between the system operator 10 and the web page owners 8 may be conducted via financing institutions.

The advertiser 6 places images and descriptions of the commodity on the commodity web page 4, and makes sales of the commodity in response to purchase orders from the customers 1. The commodity web page 4 has a link to the ordering page 11, so that the commodity displayed in the commodity web page 4 can be ordered from the ordering page A variety of web pages can be the banner-carrying web pages 3. The owners 8 of these web pages 3 place the banner advertisement 2 on their web pages for a purpose of earning a payment from the advertisement. The present invention assumes, as shown in FIG. 1, that there are at least two banner-carrying web pages 3 and their owners 8.

The system operator 10 is the primary entity in the operation of the present banner advertisement system, and manages/operates the present banner advertisement system by using the system database server 5.

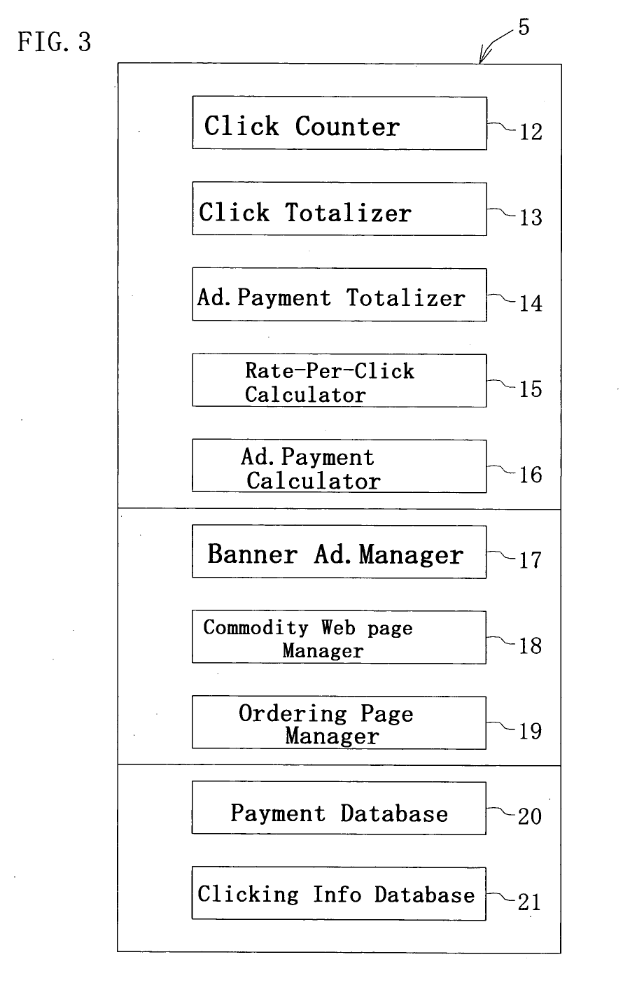

FIG. 3 outlines a configuration of the system database server 5. The system database server 5 includes a click counter 12 capable of counting the number of clicks made on the banner advertisement 2 placed in each of the banner-carrying web pages 3, a click totalizer 13 capable of obtaining a total number of clicks made on the banner advertisement 2 in all of the banner-carrying web pages 3a-3e, a total advertisement payment calculator 14 which calculates a total value of payment for the banner advertisement 2 in the commodity web page 4, a rate-per-click calculator 15 which calculates a rate to be paid for each click on the banner advertisement, and an advertisement payment calculator 16 which calculates a payment for the advertisement 2 in each of the banner-carrying web pages 3a-3e. Each of the above-mentioned counter, totalizer and calculators serve in calculation of the amount of payment to be made to each of the owners 8 of the banner-carrying web pages, and are stored in the form of program at the server.

The system database server 5 also stores a variety of managing means for the operation of the present banner advertisement system. According to the present embodiment, these managing means include a banner advertisement manager 17 capable of managing the banner advertisement placed in each of the banner-carrying web pages 3a-3e, a commodity web page manager 18 for management of the commodity web page 4, and an ordering page manager 19 for management of the ordering page 11 displayed as a link from the commodity web page 4.

In addition, there is provided a number of databases containing a variety of data for the above-described means to function. According to the present embodiment, these databases include a payment database 20 which stores values of predetermined success rewards and so on, and a clicking information database 21 which can store e.g. the numbers of clicks counted. It should be noted here that according to the present embodiment, an operating fee is paid to the system operator 10 in accordance with the number or value of the commodities sold.

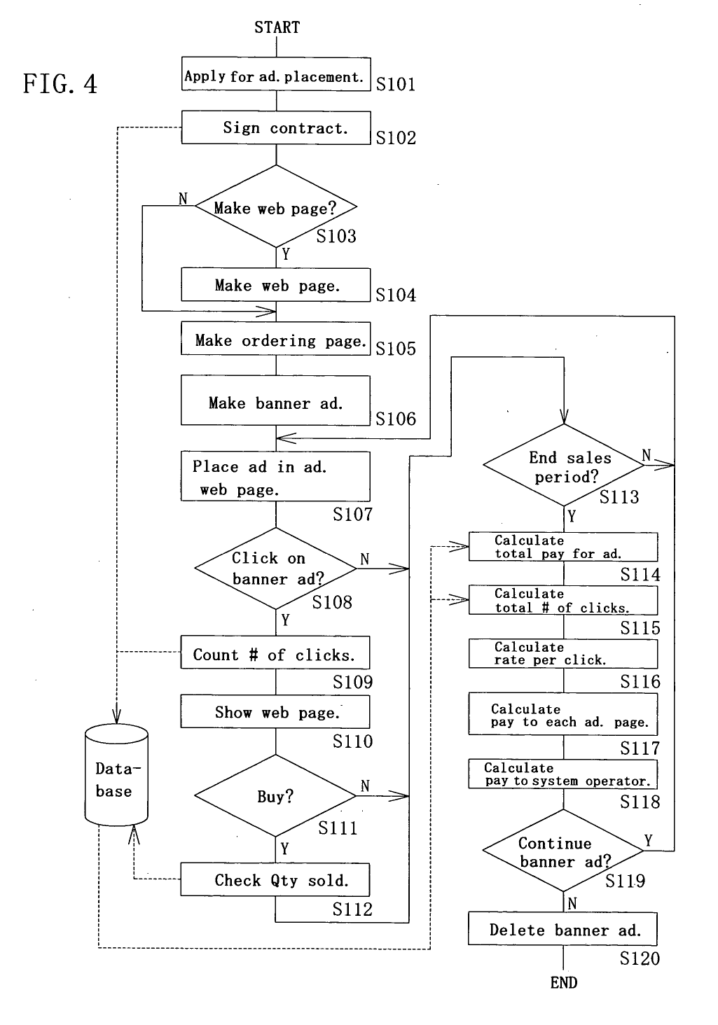

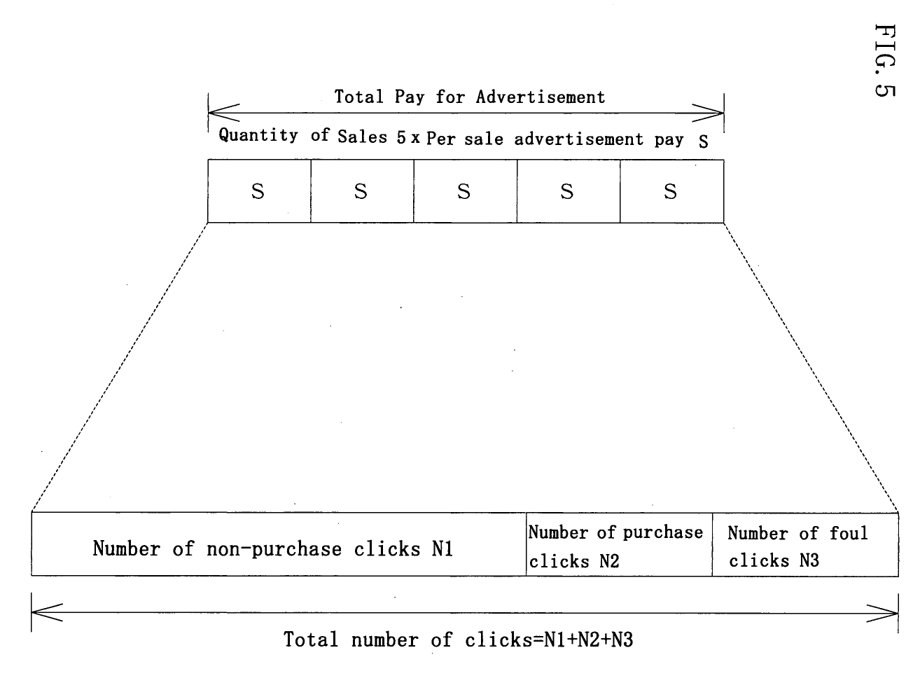

FIG. 4 shows a sample flowchart of the banner advertisement system according to the present embodiment. When an offer to put an advertisement is made to the system operator 10 (S101), a contract is made on the period, payment and so on of the advertisement (S102). According to the present embodiment, as shown in FIG. 5, an agreed percentage of a unit price of the commodity to be advertised is used as a rate to be paid for the advertisement per sale, and a total payment for advertisement is calculated by multiplying the per-sale advertisement rate S by the number of the commodities sold. For example, as shown in FIG. 5, if a total of five commodities are sold, a total payment for the advertisement will be 5×S.

Though not illustrated, the system operator 10 receives an operator's fee in accordance with the number or value of the commodities sold. It should be noted that there is no specific limitation on how to calculate the total advertisement payment or the fee to be paid to the system operator. These may be calculated in a variety of methods.

Next, a determination is made on whether a commodity web page is to be made or not (S103). If a commodity web page already exists, the system can use this web page. On the other hand, if a commodity web page is not made yet, a commodity web page is created (S104), and the commodity web page 4 is managed by the system database server 5. Alternatively, the system may create a commodity web page newly and manage it in all cases.

According to the present embodiment, an ordering page 11 linked from the commodity web page is created (S105). The ordering page 11 is managed by the system database server 5 which keeps track on the kind, number and so on of the commodity sold via the banner advertisement 2.

Next, a banner advertisement 2 to be linked to the commodity web page 4 is created (S106). There is no specific limitation to the type of the banner advertisement 2. Specifically, the banner advertisement may be a combination of pictures and text, or it may only contain a text. Or, the advertisement may contain a motion picture.

Next, the banner advertisement 2 is placed on each of the banner-carrying web pages 3 (S107). The banner-carrying web pages are pooled in advance through the Internet for example, and the banner advertisement is placed in selected ones of these pages, taking into account the contents of the web pages and the commodity promoted in the advertisement.

Means can be provided for automatic creation of the commodity web page 4, the ordering page 11 and the banner-carrying web pages 3. By creating the commodity web page and others automatically, it becomes easy to operate and manage the present advertisement system. When a customer 1 views the banner-carrying web pages 3, and clicks on the banner advertisement 2 (S108: Y), the clicking information is outputted to the system data server, where the number of clicks are counted and stored in the click information database (S109).

Upon clicking on the banner advertisement 2, the commodity web page 4 is displayed in the customer terminal 7 and viewed by the customer 1 (S110). If the customer 1 views the commodity web page 4 and makes a purchase via the ordering page 11 (S111: Y), purchase information is outputted to the system database server, where the number of commodities purchased is counted and stored in the database (S112).

The banner advertisement 2 is placed for a predetermined advertising period. The clicking information and the purchase information is counted and updated until the advertisement period expires (S113: N).

Upon expiration of the advertisement period (S113: Y), a total advertisement payment is calculated (S114). As shown in FIG. 5, according to the present embodiment, the total advertisement payment is given by multiplying a total number of commodities sold by the per-sale advertisement rate S which represents an amount of payment per sale of the commodity.

Next, the numbers of clicks in all of the banner-carrying web pages 3a-3e are accumulated to obtain a total number of clicks (S115). Then the total advertisement payment is divided by this total number of clicks to obtain a rate per click (S116). Next, the rate per click is multiplied by the number of clicks at each of the banner-carrying web pages, to obtain an advertisement payment for each of the banner-carrying web pages (S117). The advertisement payment thus calculated is then paid to the corresponding owners of the web pages. On the other hand, the system operator is also paid in accordance with the method described earlier (S118).

Then, determination is made if the banner advertisement is continued. When selection is made for continuation (S119: Y), the process goes back to the cycle already described above. According to the present embodiment, no advertisement payment will result if no click is made on the banner advertisement. If selection is made for not to continue with the banner advertisement on the other hand, (S119: N), the banner advertisement is deleted (S120).

The rate per click is determined in relation to the number of commodities sold and the total number of clicks made on the banner advertisement. As shown in FIG. 5, the total number of clicks includes the number of non-purchase clicks N1 or the number of clicks which were made but did not yield a purchase, the number of purchase clicks N2 or the number of clicks which were made and yielded a purchase, and the number of foul clicks N3 or the number of clicks which were made just to earn the count on the number of clicks. With this calculation, influence by the number of foul clicks becomes remarkably smaller than in a banner advertisement system which uses a click-counting type payment calculation method where advertisement payment is calculated by multiplying a fixed rate-per-click by the number of clicks. This leads to an advantage of discouraging attempts to make foul clicks.

The advertiser 6 should only pay an advertising expense to the system operator 10 in accordance with the success, and thus does not inflict a loss from foul clicking. It should be noted here that the present embodiment allows for an operating fee in accordance with the quantity of commodities sold, but the payment to the system operator may not be limited to this.

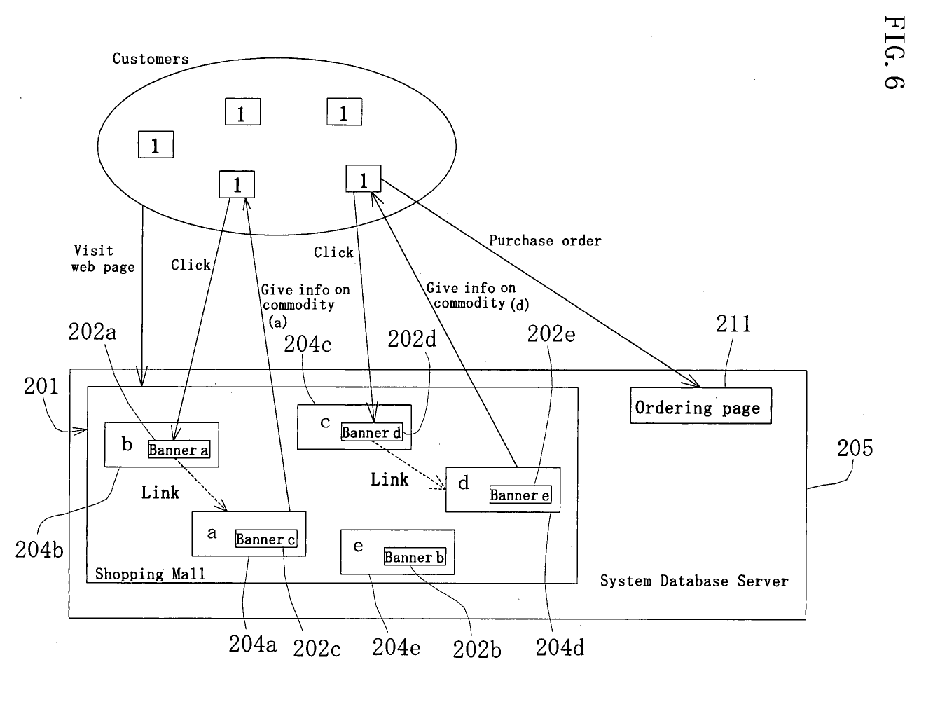

FIG. 6 through FIG. 9 show a second embodiment of the present invention. This embodiment is an application of a banner advertisement method according to the present invention to an Internet shopping mall.

An Internet shopping mall is a collection of on-line shops, like a real department store or a shopping mall. A shopping mall offers a rich collection of commodities and information thereof, providing opportunities to make comparison on prices and qualities even when buying the same brand. Therefore, putting a banner advertisement on a relevant commodity web page in the same shopping mall can significantly increase the amount of information readily accessible by consumers, and increases the function of the shopping mall.

On the other hand, putting a banner advertisement of a commodity identical with the commodity that one plans to promote or a similar commodity offered by others will create a competing situation on one's own web page. However, placing each other's banner advertisements can also increase frequency that a clicking is made on one's own banner advertisement, which leads the viewer to one's own commodity web page and to promoted sales of one's own commodity.

FIG. 6 shows an outline of a shopping mall system according to the present embodiment. In the present embodiment, a shopping mall 201 includes commodity web pages 204a-204e. The commodity web pages promote commodity (a)—commodity (e) and show information thereof respectively. Further, each of the commodity web pages 204a-204e carries banner advertisements 202a-202e which are competitors' advertisements each promoting an identical or similar commodity. Purchase of the commodity is made through an ordering page 211 which is linked from each of the commodity web pages. Although FIG. 6 shows only one ordering page 211, the ordering page is created and linked specifically for each of the commodity web pages. The commodity web pages 204a-204e and the ordering pages 211 according to the present embodiment are created and stored in a system database server 205.

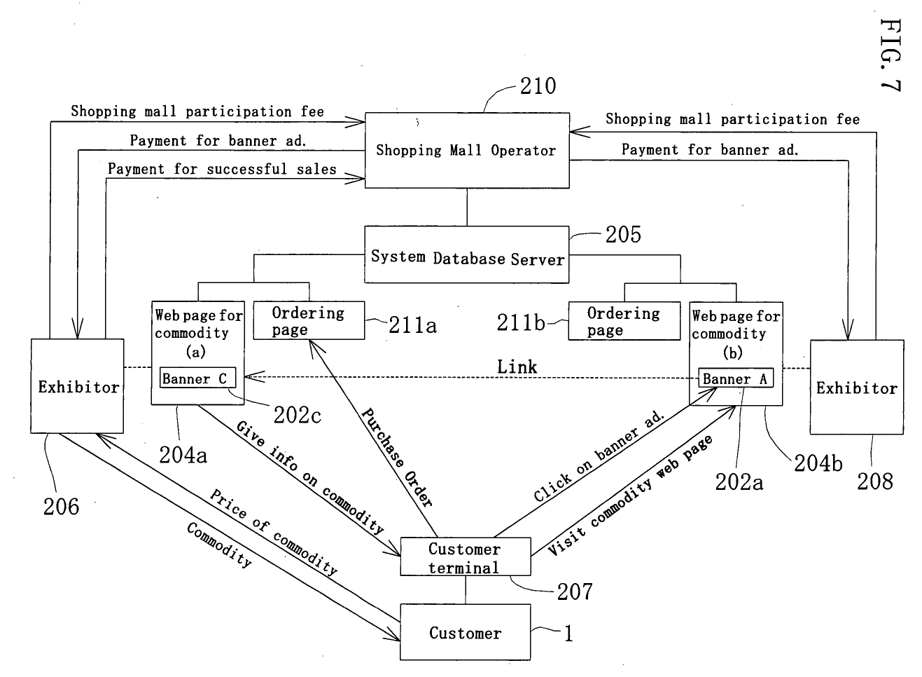

FIG. 7 shows the commodity web pages 204a and 204b, to show how the system will work when the commodity (a) is purchased through the banner advertisement which features the commodity (a) and is placed in the commodity web page 240 (b).

FIG. 7 shows a banner advertisement system involving an exhibitor 206 who promotes the commodity (a), an exhibitor 208 who promotes the commodity (b), a shopping mall operator 210 who owns the system database server 205, and a customer 1 who views the commodity web pages in the shopping mall via a terminal 207.

The customer 1 uses the terminal 207 to see each of the commodity web pages 204a, 204b, looking for things to buy, and if there is, makes a purchase through the ordering page 211a or 211b. The commodity web pages 204a, 204b feature the commodity (a) of the exhibitor 206 and the commodity (b) of the exhibitor 208 respectively, using images, text and so on of the commodities.

The commodity web pages 204a, 204b carries banner advertisements 202c, 202a respectively, and clicking on the banner advertisement will bring the viewer to a corresponding commodity web page through a link. Thus, the viewer can go back and forth between the commodity web pages via the banner advertisements.

The commodity exhibitors 206, 208 pay a shopping mall participant fee to the shopping mall operator 210. When the commodity (a) is sold, the exhibitor 206 of the commodity (a) pays a sales success reward in addition to the shopping mall participant fee.

On the other hand, the shopping mall operator 210 pay to the exhibitor 206, 208, a payment for banner advertisement in accordance with the number of clicks made on the banner advertisements 202a, 202c. Details of the transaction between the exhibitor 206, 208 and the customer are the same as already described for the first embodiment, and so will not be repeated here.

Conventional on-line shopping malls provide a search engine for visitors to search for commodities they are looking for. However, in order for them to open commodity web pages featuring the same or similar products, the visitors have to go back to a category page or a contents page for example, or it is necessary to input a key word for example.

According to the present embodiment, when a visit is made to a commodity web page, the web page will show banner advertisements featuring the same or similar commodities, which makes it remarkably convenient to make comparisons among the commodities. Further, direct links to similar or relevant commodities provide remarkable improvement on ease and conveniences.

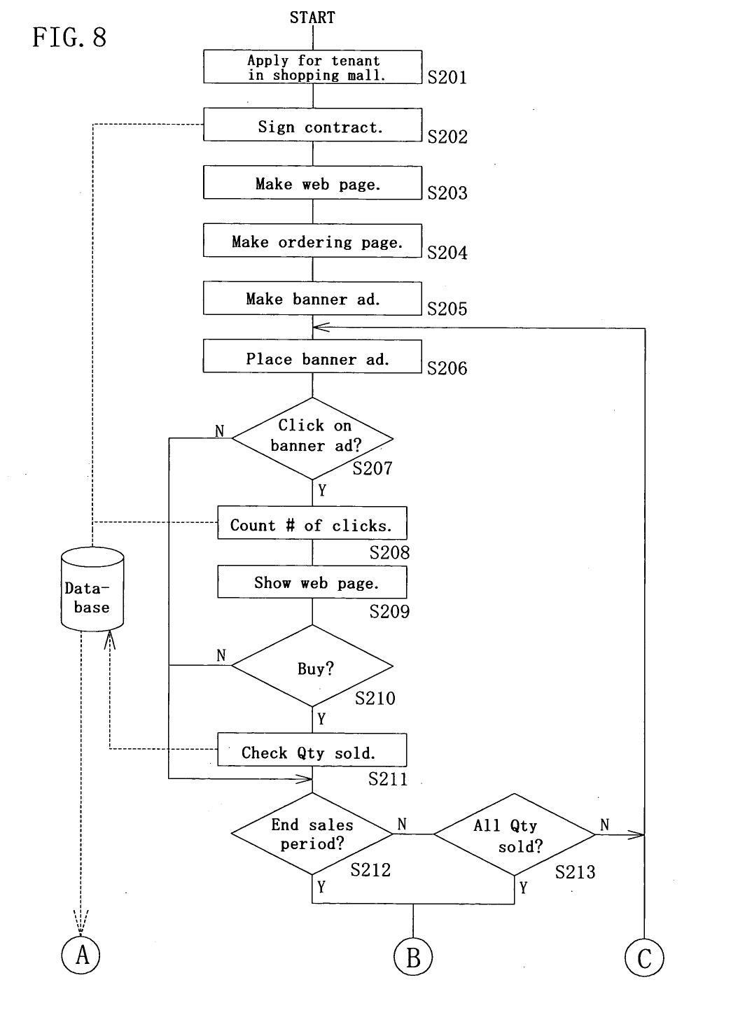

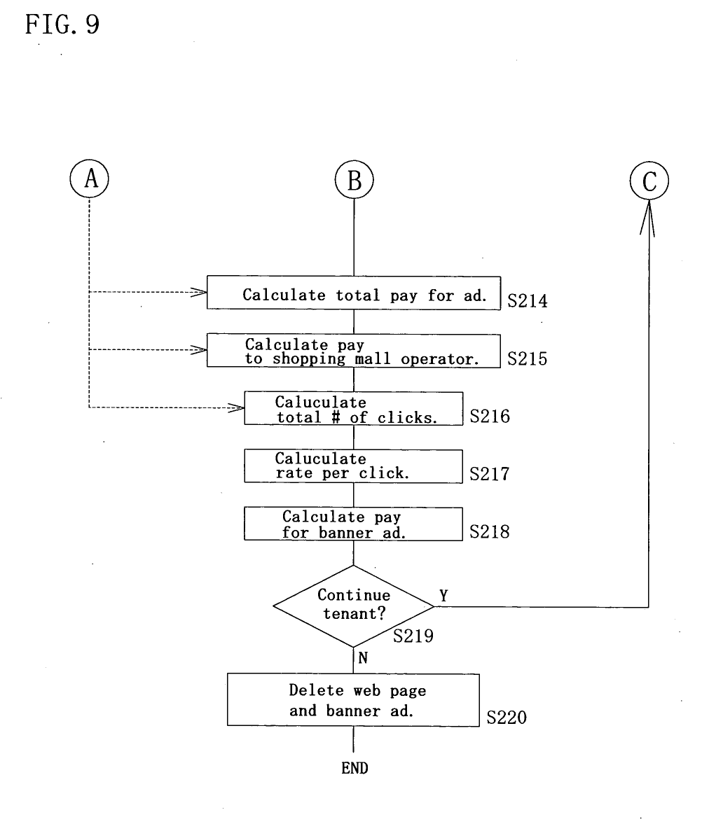

Reference will be made here to flowcharts given in FIG. 8 and FIG. 9, to describe the banner advertisement method in a shipping mall configured as the above.

When an exhibitor applies to a shopping mall (S201), a tenant contract is made (S202). The tenant contract includes essences such as calculation methods for a shopping mall participant fee, a sales success reward, a payment for banner advertisement, a shopping mall operator's fee and so on.

After the contract is made, a commodity web page and an ordering page are created and made available for viewing (S203, S204). According to the present embodiment, commodity web pages and ordering pages are automatically created when an exhibitor 206 and an exhibitor 208 send commodity information on their offers such as images and texts of a commodity (a) and a commodity (b) to the system database via the Internet.

Then, a banner advertisement is created (S205), and placed on other commodity web pages (S206). The commodity web pages on which the banner advertisement is placed are selected in accordance with the category, features and so on of the commodity promoted in the banner advertisement.

When the banner advertisement placed on any of the commodity web pages is clicked (S207: Y), the clicking information is outputted to the system database server 205, where the number of clicks are counted (S208), while the linked commodity web page are visited (S209).

If a purchase is made to the commodity promoted in the visited commodity web page via the ordering page 211, purchase information is outputted to the system database server, where the number of commodities purchased is counted and stored in the database, together with other information (S211).

Upon expiration of the sales period (S212: Y) or completion of the number of sales planned (S213: Y), an accounting process including calculation of an advertisement payment is commenced. If the sales period is not expired (S212: N) and the number of sales has not yet reached the planned quantity (S213: N), the commodity web page is kept as accessible and the banner advertisements continue to be placed.

In the accounting process shown in FIG. 9, a total advertisement payment and the shopping mall operator's fee are calculated, based on the number of sales achieved (S214, S215). In addition, as in the first embodiment, a total number of clicks are calculated (S216), and the total advertisement payment is divided by the total number of clicks to obtain a rate per click (S217). Then, the rate per click is multiplied by the number of clicks at each of the banner-carrying web pages, to obtain an advertisement payment for each of the banner-carrying web pages (S218).

After the accounting process is over, determination is made if the participation is continued (S219). When selection is made for continuation (S219: Y), the banner advertisement and the commodity web page are continued. On the other hand, if selection is made for terminating the participation, (S219: N), the commodity web page and the banner advertisement are deleted (S220).

The shopping mall according to the present embodiment enables shopping while making comparisons among commodities of the same and similar natures as well as relevant commodities. Further, it is now possible to make comparison among commodities of similar natures all at a time, making it possible to remarkably increase the function of shopping mall.

On the other hand, the exhibitor is given an opportunity to promote his commodity through banner advertisements. This enables to remarkably increase the number of visitors to the commodity web page. Moreover, since the advertising expense on the banner advertisement is proportional to the quantity of sales, the cost of advertising does not pose too much burden on the exhibitor. Furthermore, the exhibitor can expect payment from banner advertisements placed on his commodity web page, which makes it possible to increase the number of exhibitors.

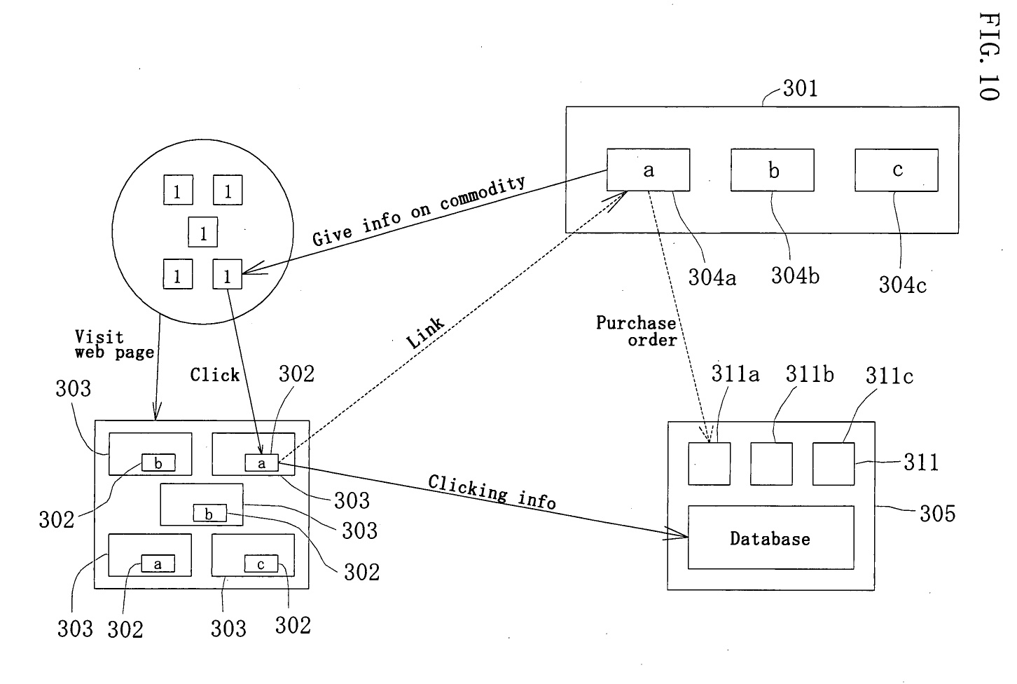

FIG. 10 shows a third embodiment of the present invention. This embodiment is a case where a shopping mall operator is different from a banner advertisement system operator. Calculation methods for advertisement payment and others will not be described here since they are the same as in the second embodiment.

A shopping mall 301 includes commodity web pages 304a, 304b, 304c, and a banner advertisement 302 relevant to these commodity web pages are placed on web pages 303 out of the shopping mall 301. The system operator creates and places the banner advertisements 302 on the web pages 303, and gathers such information as clicking information. The operator also creates, in the system database server 305, ordering pages 311a, 311b, 3121c for the commodity web pages respectively and gathers such information as sales status.

The above arrangement enables to increase promotion through a large number of commodity web pages 303 which do not belong to the shopping mall 301, thereby promoting sales from the shopping mall.

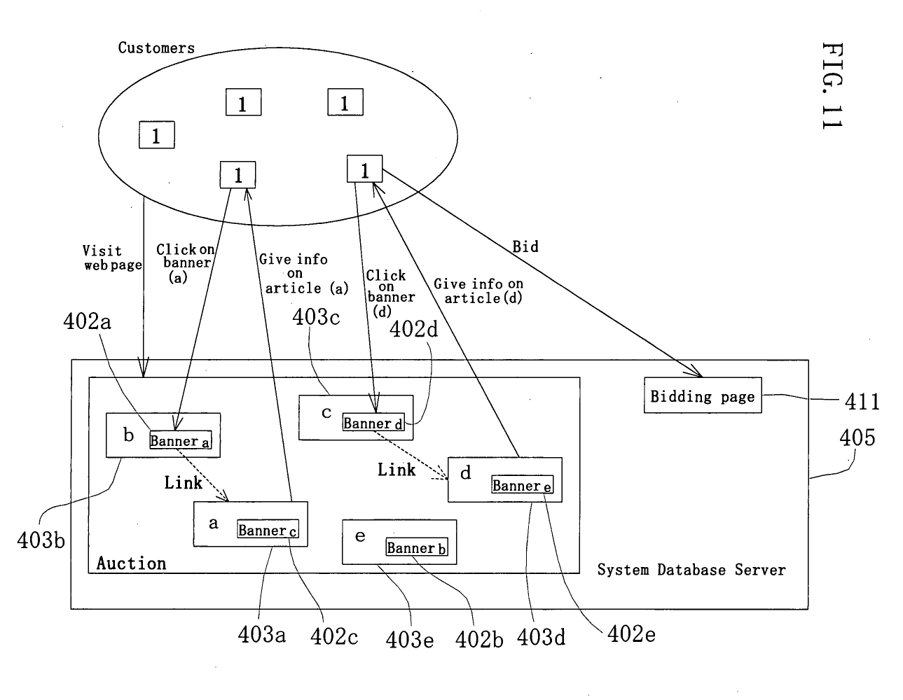

FIG. 11 through FIG. 15 show a fourth embodiment of the present invention. This embodiment is an application of the present invention to an Internet auction system.

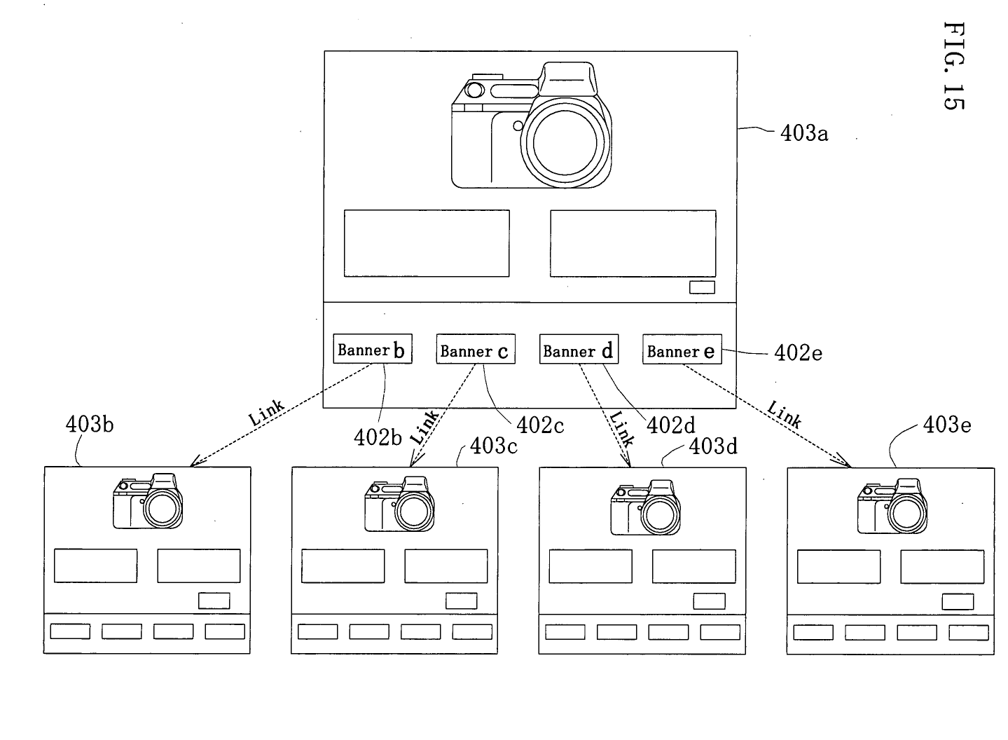

An auction system is created in a system database server 405, which includes auction article web pages 403a-403e each containing images and texts and so on of an article offered. Each of the auction article web pages shows banner advertisements 402a-402e each features another of the articles offered in the auction. Preferably, the articles featured in the banner advertisements should be of the articles offered in the auction article web pages or of a relevant article. Although FIG. 11 shows only one of the banner advertisements 402a-402e for each of the auction article web pages 403a-403e, in reality, as shown in FIG. 15, each of the auction article web pages carries a plurality of the banner advertisements, so that the visitor can compare the articles offered in the auction by clicking and visiting different auction article web pages linked from the banner advertisements.

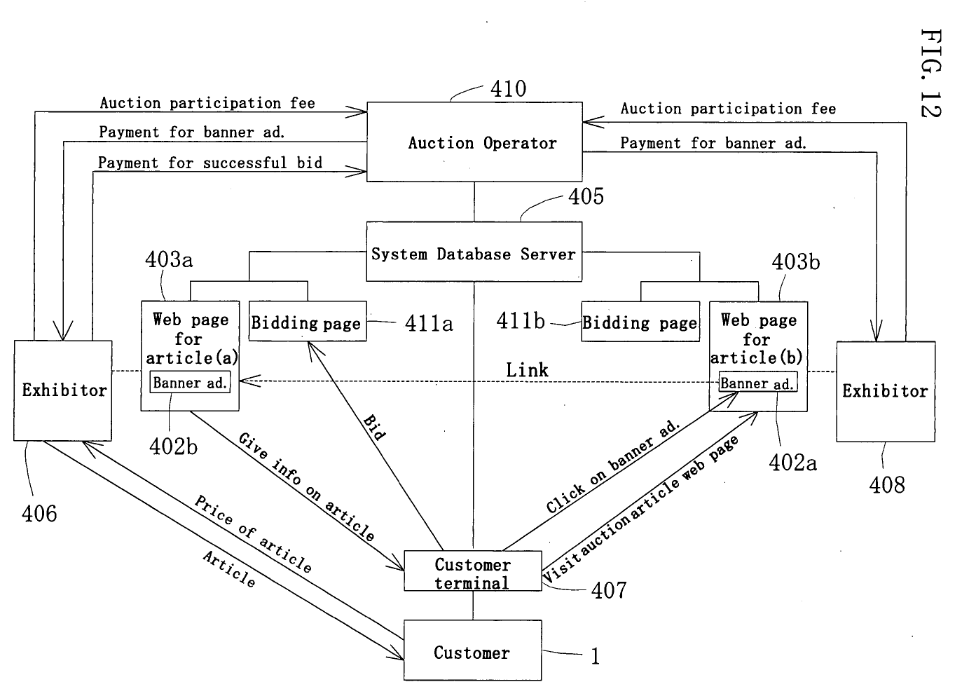

FIG. 12 shows the auction system, a sample case where there are two exhibitors. An auction operator 410 owns a system database server 405, creates auction article web pages, bidding pages and soon in the system database server 405, and runs the auction.

Exhibitors 406, 408 apply for participation to exhibit an article in the auction, via the Internet to the database server 405. The exhibition of the articles is made automatically, through automatic creation of auction article web pages and the bidding pages when images, texts and so on of the articles are sent via the Internet.

A customer 1 uses a terminal 407 such as a computer to visit the auction article web pages. Clicking on the banner advertisements 402a, 402b in any of the auction article web pages will display a corresponding auction article web page on the link.

The exhibitors 406, 408 pay an auction participation fee to the auction operator 410, and pay a successful-bid reward if the article is successfully bid. The auction operator 410 pays to the exhibitors 406, 408 a banner advertisement payment for a banner advertisement if there is a successful bid to an article featured in the banner advertisement. The payment is made in accordance with the number clicks made on the banner advertisements. Delivery of the bid article and payment between the exhibitor and the customer are made as conventionally.

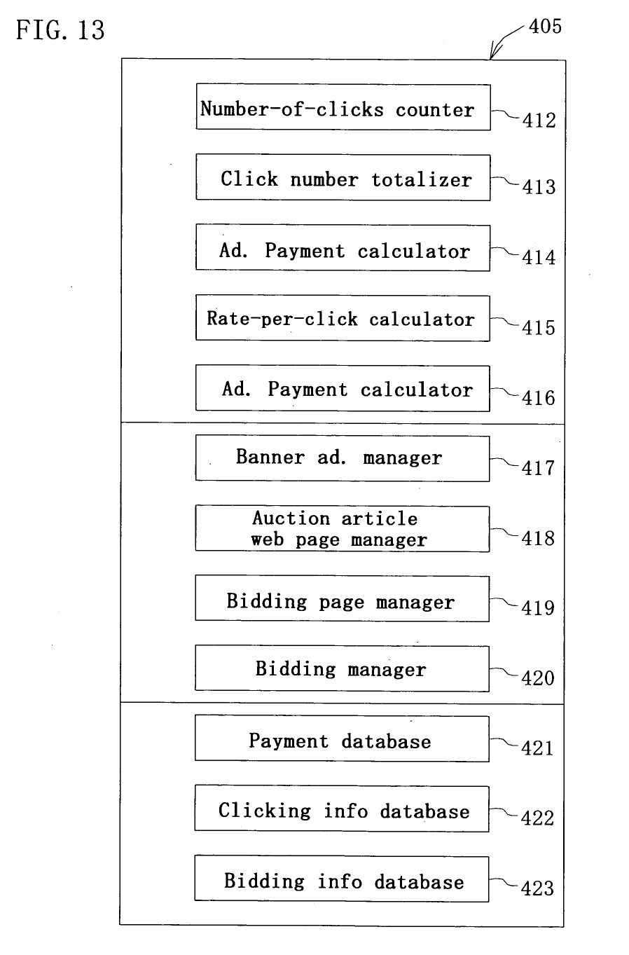

As shown in FIG. 13, the system database server 405 includes a click counter 412 which counts the number of clicks made on the banner advertisement, a click totalizer 413 which accumulates to give a total number of clicks made on the banner advertisements, for each article, an advertisement payment calculator 414 which calculates an advertisement payment based on a successful bidding price, a rate-per-click calculator 415 which makes a dividing calculation of dividing the advertisement payment by the total number of clicks thereby obtaining a rate per click, and an advertisement payment calculator 416 which calculates an advertisement payment for each banner advertisement in each of the auction article web pages by multiplying the rate per click by the number of clicks counted for each banner advertisement. In reality, an auction article web page contains a plurality of banner advertisements. Therefore, the above calculations are made for each of the articles which are successfully bid, and the advertisement payment is calculated for each of the web pages. Each of the above-mentioned counter, totalizer and calculators are stored in the form of program in the system database server.

The system database server 405 also includes a banner advertisement manager 417, an auction article web page manager 418, and a bidding page manager 419, and a bidding manager 420.

In addition, for the above-described means to function, databases are provided, including a payment database 421 which stores calculation methods of advertisement payment and so on agreed in the process of contract making, a click information database 422, and bidding information database 423.

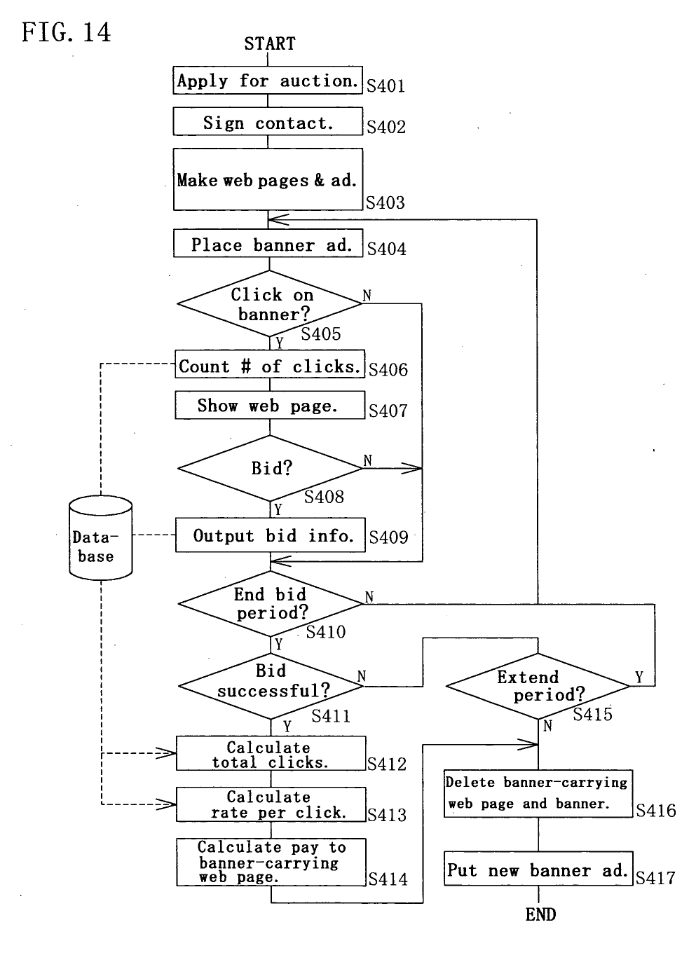

FIG. 14 shows how an auction system according to the present embodiment will be operated.

When exhibitors 406, 408 apply for an auction (S401) an auction contract is made (S402). The auction contract includes essences such as a participation fee, reward on successful bid and how they are calculated.

After the contact is made, auction article web pages, banner advertisements and bidding pages are created (S403). Then, the auction article web pages are made available for viewing and the banner advertisements are placed on other auction article web pages (S404).

For example, if a customer 1 using a terminal 407 clicks on a banner advertisement 402a placed on one of the auction article web pages, clicking information is outputted to the database, and the number of clicks is counted (S406), while an auction article web page 403a on the link is displayed and viewed (S407).

The customer uses the banner advertisements to make instant visits to auction article web pages featuring articles of the same or similar categories. If he finds a desired article (a), he makes a bid (S408) via the bidding page 411 which is made available through a link from the auction article web page 403a. Upon the bidding, relevant information such as bidding price offered is outputted to and stored in the database (S409).

The bidding is made within a predetermined period. Upon expiration of the bidding period (S410: Y), the bidding manager 420 finds the successful bidder who offered the highest price for the article on auction (S411). Bidding procedures are the same as in conventional system and will not be described here.

When the article has been bid successfully, a total number of clicks on the banner advertisements placed in the auction article web pages is calculated (S212). Then, a banner advertisement expense deducted from the successful-bidding reward is divided by the total number of clicks to obtain a rate per click for the banner advertisement (S413). Then, the rate per click is multiplied by the number of clicks at each of the banner-carrying web pages, to obtain an advertisement payment on this particular article to be paid to each of the banner-carrying web pages (S414). If a plurality of articles have been bid successfully, the calculations of the advertisement payment are performed for each of these articles, and a sum of the results is obtained as the advertisement payment for this particular bidding session.

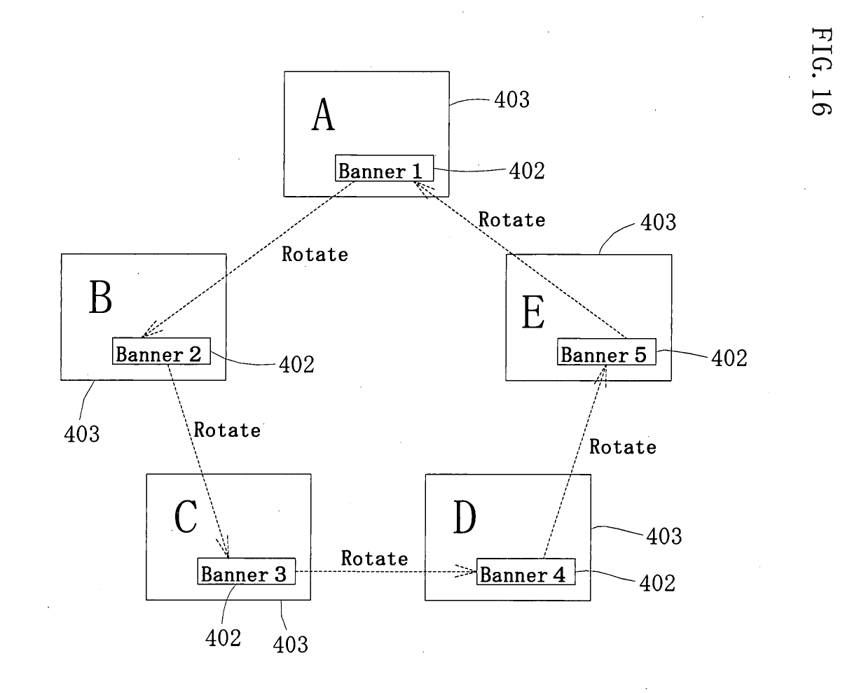

The banner advertisements 402 placed in the auction article web pages 403 should preferably be replaced with another by rotation, as shown in FIG. 16, at a predetermined time interval during the period of auction. This allows making comparison among a greater number of relevant articles on the auction, making it easier to participate in the auction.

Upon the success in the bidding, the auction article web page, the banner advertisement and the bidding page therefor are deleted (S416). Thereafter, another banner advertisement featuring a new article is placed on each of the auction article web pages (S417).

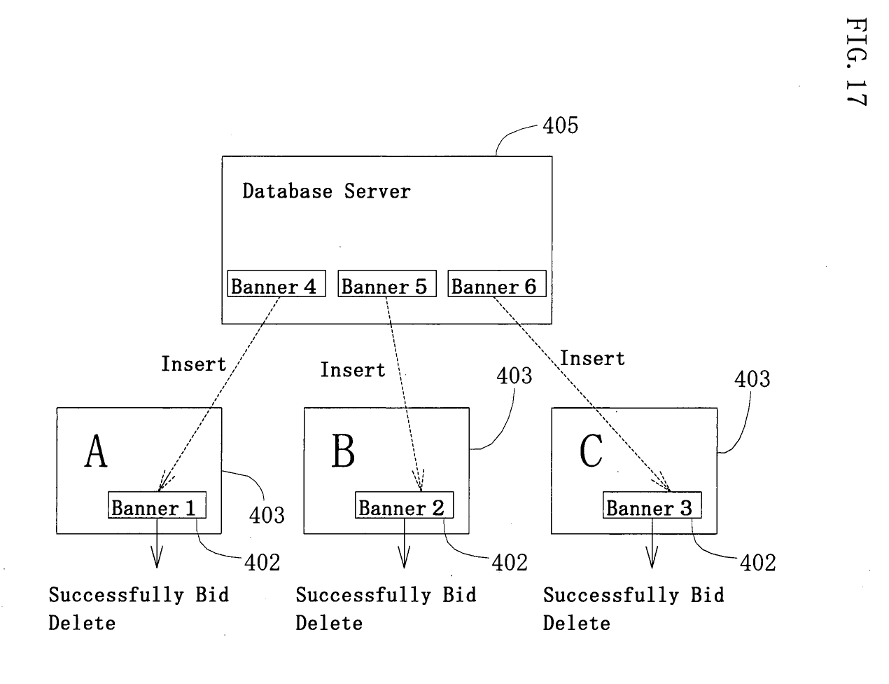

If the article has not been successfully bid before the expiration of the bidding period (S411: N), determination is made if the bidding period is extended. When selection is made for extended bidding period (S415: Y), the auction article web pages and others are continued. If selection is made for not to extend the bidding period, (S415: N), the auction article web page and others are deleted (S416), process of the auction relevant to this particular cycle is terminated, and another auction article web page and a banner featuring a new article is placed (S417). As shown in FIG. 17, banner advertisements for new articles are stored in the system database server 405, and the deletion of the obsolete banner advertisement and placement of a new banner advertisement in each auction article web page are made automatically.

The present invention is not limited to the embodiments so far described above. According to the embodiments, an owner of a banner-carrying web page receives an advertisement payment for the placement of a banner advertisement and a success reward from successful sales of goods for example. However, in addition to these payments, a payment may also be made for the number of visits made to the web page which carries the banner advertisement, as a reward-on-visit to the banner-carrying web page.

This makes sense because even if clicking is not made on the banner advertisement, a certain level of advertisement effect can be expected as long as the banner advertisement is displayed. Further, if the web page is a place of frequent visit by customers, a high level of effect can be expected from placing an advertisement, and it is possible to use a differentiation policies to web pages in which banner advertisement are to be placed. Further, in general, a web page of frequent visit by viewers will yield a large number of clicks and a high level of effect. Therefore, use of the reward-on-visit enables selective use of the banner-carrying web pages.

1. A banner advertising method involving two or a greater number of banner-carrying web pages each carrying a banner advertisement relevant to an object of advertisement, and an advertisement web page accessible by clicking on the banner advertisement to an advertisement of the object, each of the web pages being provided on Internet, the method calculating an advertisement payment for the banner advertisement through steps including:
a click counting step of counting clicks made on the banner advertisement in each of the banner-carrying web pages within a predetermined period of time;
a click totalizing step of obtaining a total number of clicks by totalizing the counts of clicks made in all of the banner-carrying web pages;
a rate-per-click calculating step of calculating a rate to be paid for each of the clicks, by dividing a total advertisement payment for the banner advertisement by the total number of clicks; and
an advertisement payment calculating step of calculating an advertisement payment for the banner advertisement in each of the banner-carrying web pages, by multiplying the rate by the count of clicks in each of the banner-carrying web pages.

2. The banner advertising method according to claim 1, further including:
an advertising outcome calculating step of calculating an outcome from the web page visited via the banner advertisement, for each of the banner-carrying web pages;
a total outcome calculating step of calculating a total outcome, by totalizing the outcomes for all of the banner-carrying web pages; and
a total advertisement payment calculating step of calculating the total advertisement payment based on the total outcome.

3. The banner advertising method according to claim 2, further including a success reward calculating step of calculating a success reward based on the outcome for each of the banner-carrying web pages, for the success reward to be added to the advertisement payment.

4. The banner advertising method according to claim 2, wherein the object of advertisement relates to a commodity or service for sale, the outcome being provided by a quantity of sales and/or a value of sales of the commodities or service,
the calculation of the total advertisement payment being based on the quantity of sales and/or the value of sales.

5. The banner advertising method according to claim 4, wherein the advertisement web page has a link to an ordering page, purchase of the commodity or service and counting of the outcome being made via the ordering page.

6. The banner advertising method according to claim 5, wherein a predetermined success reward is appropriated for an owner of the banner-carrying web page if a purchase order is made through the ordering page.

7. The banner advertising method according to claim 1, wherein the advertisement web page and/or the banner-carrying web pages are provided by commodity web pages constituting a shopping mall on the Internet.

8. The banner advertising method according to claim 3, wherein the object of advertisement is information gathering, the system calculating the advertisement payment and/or the success reward as well as a cooperation reward to information providers.

9. A banner advertising method in Internet auctioning for advertising an article offered in an auction conducted on Internet, including:
creation of an auction article web page featuring the article, and a bidding page linked to the auction article web page, and
placement of a banner advertisement linked to the auction article web page in another auction article web page which belongs to the auction and/or a banner-carrying web page which does not belong to the auction.

10. The banner advertising method in Internet auctioning according to claim 9, including:
a click counting step of counting clicks made on the banner advertisement in each of the web pages within a predetermined bidding period;
a click totalizing step of obtaining a total number of clicks by totalizing the counts of clicks made in all of the web pages in which the banner advertisement is placed;
a rate-per-click calculating step of calculating a rate to be paid for each of the clicks, by dividing a total advertisement payment for the banner advertisement by the total number of clicks; and
an advertisement payment calculating step of calculating an advertisement payment for the banner advertisement in each of the web pages, by multiplying the rate by the count of clicks at each of the web pages.

11. The banner advertising method in Internet auctioning according to claim 9, wherein a successful-bid reward is appropriated for a web page in which the banner advertisement is placed, if the article has been successfully bid by a bidder who made a visit, via said web page, to the auction article web page.

12. The banner advertising method in Internet auctioning according to claim 9, wherein the banner advertisement placed in each web page is replaced by another banner advertisement at a predetermined time interval.

13. A banner advertising system involving two or a greater number of banner-carrying web pages each carrying a banner advertisement relevant to an object of advertisement, and an advertisement web page accessible by clicking on the banner advertisement to an advertisement of the object, each of the web pages being provided on Internet, the system calculating an advertisement payment for a visit to the advertisement web page via a click made on the banner advertisement, the system including:
a click counter capable of counting clicks made on the banner advertisement in each of the banner-carrying web pages within a predetermined period of time;
a click totalizer for obtaining a total number of clicks by totalizing the counts of clicks made in all of the banner-carrying web pages;
an outcome calculator for calculating an advertising outcome from the banner advertisement in each of the banner-carrying web pages;
a total outcome calculator for calculating a total outcome, by totalizing the outcomes in all of the banner-carrying web pages; and
a total advertisement payment calculator for calculating the total advertisement payment based on the total outcome.
a rate-per-click calculator for calculating a rate to be paid for each of the clicks, by dividing a total advertisement payment for the banner advertisement by the total number of clicks; and
an advertisement payment calculator for calculating an advertisement payment for the banner advertisement in each of the banner-carrying web pages, by multiplying the rate by the count of clicks in each of the banner-carrying web pages.

14. (Canceled)

15. The banner advertising system according to claim 13, further including a success reward calculator for calculating a success reward based on the outcome for each of the banner-carrying web pages.

16. The banner advertising system according to claim 13, wherein the outcome calculator calculates the outcome via an ordering page linked to the advertisement web page.

17. The banner advertising system according to claim 13, further including an automatic creator for creation of the banner advertisement and/or the ordering page.

18. A banner advertising system in an Internet auction involving auction article web pages each featuring an article offered in the auction, bidding means including a bidding page linked to the auction article web pages, and a selector for selecting a successful bidder;
wherein the system places a banner advertisement linked to the auction article web pages in other auction article web pages which belong to the auction and/or banner-carrying web pages which do not belong to the auction;
and including: a click counter capable of counting clicks made on the banner advertisement in each of the web pages within a predetermined period;
a click totalizer for obtaining a total number of clicks by totalizing the counts of clicks made in all of the banner-carrying web pages;
a total advertisement payment calculator for calculating the total advertisement payment based on a price and/or a quantity of the article which has been successfully bid;
a rate-per-click calculator for calculating a rate to be paid for each of the clicks, by dividing a total advertisement payment for the banner advertisements by the total number of clicks; and
an advertisement payment calculator for calculating an advertisement payment for the banner advertisement in each of the banner-carrying web pages, by multiplying the rate by the count of clicks in each of the banner-carrying web pages.

19. (Canceled)

20. (Canceled)

21. The banner advertising system in an Internet auction according to claim 18, further including a success reward calculator for calculating a success reward based on the price and/or the quantity of the article which has been successfully bid, for the web pages in which the banner advertisement is placed.

22. The banner advertising system in an Internet auction according to claim 18, further including an automatic banner advertisement creator for creation of the banner advertisement relevant to the article.

23. The banner advertising system in an Internet auction according to claim 18, further including a banner advertisement placer for automatic selection of a web page which is in a predetermined relationship with the auction article featured in the banner advertisement, and automatic placement of the banner advertisement in the selected web page.

24. The banner advertising system in an Internet auction according to claim 18, further including a web page creator for automatic creation of the auction article web page and/or the bidding page.

25. The banner advertising system in an Internet auction according to claim 18, wherein the internet auction includes a plurality of auction article web pages, the system further including a banner advertisement replacer for replacement of the banner advertisement with another, in each of the auction article pages at a predetermined time interval.

26. The banner advertising system in an Internet auction according to claim 18, further including a banner advertisement updater for automatic deletion of the auction article web page and the banner advertisement thereof, and automatic replacement with another auction article web page and a banner advertisement thereof.
